(19) United States
(12) Patent Application Publication
(10) Pub. No.: US 2025/0001480 A1
(43) Pub. Date: Jan. 2, 2025

(54) VARIABLE DIE AND PRESSING APPARATUS

(71) Applicant: POSCO Co., Ltd, Pohang-si, Gyeongsangbuk-do (KR)

(72) Inventors: Jae-Wook LEE, Incheon (KR); Tae-Hyo KIM, Incheon (KR)

(73) Assignee: POSCO Co., Ltd, Pohang-si, Gyeongsangbuk-do (KR)

(21) Appl. No.: 18/698,489

(22) PCT Filed: Oct. 20, 2022
(86) PCT No.: PCT/KR2022/016023

§ 371 Date: Apr. 4, 2024

(30) Foreign Application Priority Data
Oct. 20, 2021 (KR) 10-2021-0140445

(51) Int. Cl. B21D 37/10

(52) U.S. Cl. CPC B21D 37/10

(57) ABSTRACT

The present invention provides a variable die comprising an upper part and a lower part. The upper part comprises an upper cam. The lower part comprises: a lower body; a mounting portion connected to the lower body and having an object to be formed mounted thereon; and a forming portion connected to the lower body, disposed on one side of the mounting portion, and comprising a lower cam corresponding to the upper cam to linearly move in a first direction toward the mounting portion by means of the upper cam and the lower cam. The forming portion comprises: a lower cam; a base plate having the lower cam connected thereto, and formed to be movable in the first direction; actuators having one part fixed to the base plate; and a cam block connected to the actuators.

### TECHNICAL FIELD

The present disclosure relates to a variable die and a press apparatus.

### BACKGROUND ART

In the automobile industry, the use of bending methods has increased due to the trend for higher strength materials. Springback, which is inevitable in material bending processing, is a phenomenon that occurs due to complex causes, such as an elastic modulus of materials and stress distribution in a thickness direction, and it is not easy to accurately predict and correct springback.

In the bending processing field, attempts have been underway to improve precision of product forming by predicting springback. For example, a method of adding a die for compensating for springback based on the physical properties of a specific material to a production process has been used.

However, this method has been inefficient because a separate die should be manufactured depending on the material properties. In addition, even with this method, a targeted springback correction effect cannot be achieved.

In other words, although physical properties of a sample used to manufacture the die are the same as those of an actually processed material, a target springback correction effect may not appear if a processing environment changes.

For example, internal stress of materials, such as high-strength coiled steel sheets, before forming, may be different from a sample due to a difference in a coil position or coil tension, and as a result, even if the physical properties are the same, the target springback correction effect may not be achieved.
(Patent Document 1) KR 10-2010-0002958 A

### SUMMARY OF INVENTION

### Technical Problem

An aspect of the present disclosure is to provide a variable die and pressing apparatus capable of changing molding conditions to correct molding errors due to springback of a material.

### Solution to Problem

In order to achieve the above object, the following variable die and pressing apparatus are provided.

According to an aspect of the present disclosure, a variable die includes an upper die portion and a lower die portion, wherein the upper die portion includes an upper cam, the lower die portion includes a lower body, a seating portion connected to the lower body and on which a to-be-molded object is seated, and a molding portion connected to the lower body, disposed on one side of the seating portion, including a lower cam corresponding to the upper cam, and moving linearly in a first direction toward the seating portion by the upper cam and the lower cam, wherein the molding portion includes the lower cam, a base plate connected to the lower cam and configured to be movable in the first direction, an actuator partially fixed to the base plate, and a cam block connected to the actuator, wherein a plurality of actuators spaced apart in a second direction, different from the first direction, are connected to the cam block, and the actuator includes a structure extendable in the first direction.

According to an aspect of the present disclosure, a press apparatus includes a press body and a plurality of dies installed in the press body and molding a material, and a moving unit moving the material in the plurality of dies, wherein the plurality of dies include a first die bending a portion of the material and a second die re-molding a bent portion of the material formed in the first die, wherein the second die is the variable die described above.

### Advantageous Effects of Invention

The present disclosure may provide a variable die and pressing apparatus capable of changing molding conditions for correcting molding errors due to springback, through the above configuration.

In addition, the present disclosure may provide a variable die and pressing apparatus that may accurately perform molding even when the degree of springback in a single portion varies depending on a molding shape.

### BRIEF DESCRIPTION OF DRAWINGS

FIG. 1 is a schematic diagram of a die used in a related art pressing apparatus.

FIG. 2 is a schematic diagram of a molded product.

FIG. 3 is a graph illustrating molded shapes measured in positions A to D of the molded product of FIG. 2.

FIG. 4 is a conceptual diagram of a variable die according to an embodiment of the present disclosure.

FIG. 5 is a schematic front view of a variable die according to an embodiment of the present disclosure.

FIG. 6 is a schematic plan view of the variable die of the embodiment of FIG. 5;

FIGS. 7A to 7C are enlarged views of a cam block portion of FIG. 6 in each state.

FIG. 8 is a schematic diagram of a variable die according to the embodiment of FIG. 5 forming a molded article.

FIG. 9 is a graph illustrating a molded shape of a molded product molded with the variable die of the present disclosure.

* Description of reference numerals *

| | |
|---|---|
| 1: Variable Die | 10: Upper Die Portion |
| 11: Upper Cam | 20: Lower Portion |
| 21: Seating Portion | 22: Lower Body |
| 23: Base Plate | 24: Sliding Structure |
| 25: Lower Cam | 26: First Actuator |
| 27: Second Actuator | 26a, 27a: Motor |
| 26b, 27b: Screw | 26c, 27c: Moving Block |
| 26d, 27d: Support Portion | 26e, 27e: Connection Member |
| 26f, 27f: Pin | 28: Cam Block |
| 28a, 28b: First And Second Connection | |
| Holes | |

### BEST MODE FOR INVENTION

Hereinafter, embodiments will be described in detail with reference to the accompanying drawings such that they may be easily practiced by those skilled in the art to which the present disclosure pertains. In describing the present disclosure, if a detailed explanation for a related known function or construction is considered to unnecessarily divert the gist of the present disclosure, such explanation will be omitted but would be understood by those skilled in the art. Also, similar reference numerals are used for the similar parts throughout the specification. In this disclosure, terms, such as “above,” “upper portion,” “upper surface,” “below,” “lower portion,” “lower surface,” “lateral surface,” and the like, are determined based on the drawings, and in actuality, the terms may be changed according to a direction in which a device or an element is disposed.

It will be understood that when an element is referred to as being “connected to” another element, it may be directly connected to the other element or intervening elements may also be present. In contrast, when an element is referred to as being “directly connected to” another element, no intervening elements are present. In addition, unless explicitly described to the contrary, the word “comprise” and variations, such as “comprises” or “comprising,” will be understood to imply the inclusion of stated elements but not the exclusion of any other elements.

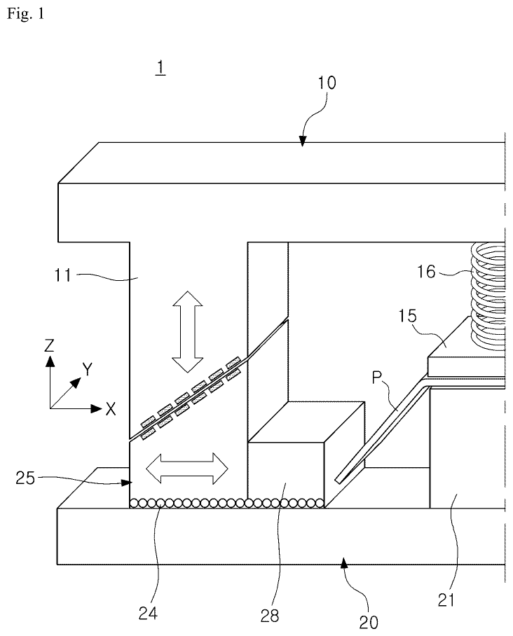

FIG. 1 is a schematic diagram of a die used in the related art pressing apparatus.

As illustrated in FIG. 1, a die 1 used in a pressing apparatus includes an upper die portion 10 and a lower die portion 20. The upper die portion 10 is connected to a movable portion moving up and down of a press body provided in the press apparatus and moves up and down together with the movement of the movable portion, and the lower die portion 20 is connected to a fixed portion of a press body. Although not illustrated, the pressing apparatus may include a moving unit positioning a to-be-molded object P between the upper die portion 10 and the lower die portion 20 and removing a molded product obtained by molding the to-be molded to-be-molded object P from the die 1, or an operator may move the to-be-molded object P or the molded product.

The pressing apparatus may be equipped with a plurality of dies to perform molding at the same time, and in the case of molding by including a cam as illustrated in FIG. 1, a cam block 28 may move in a first direction, that is, a horizontal direction to mold the to-be-molded object P, and therefore, a portion of the to-be-molded object P may be bent by performing pre-molding through another die before being molded with the die of FIG. 1 and then precisely molded with the die of FIG. 1.

In the specification of the present disclosure, an X-direction of FIG. 1 may be referred to as a width direction or a horizontal direction of the to-be-molded object P or a moving direction or the first direction of the cam block 26, a Y-direction may be referred to as a length direction, a moving direction, or a second direction of the to-be-molded object P, and a Z-direction may be referred to as a height direction, a vertical direction, or a third direction of the to-be-molded object P.

The die 1 in FIG. 1 includes the upper die portion 10 and the lower die portion 20, and the upper die portion 10 includes an upper cam 11, a pressing plate 15 for fixing a position of the to-be-molded object P during molding, and a spring 16 elastically supporting the pressure plate 15. The upper cam 11 is formed to have an inclined surface to convert a vertical movement of the movable portion of the press body into a movement in the first direction (the X-direction in FIG. 1) toward the to-be-molded object P. The lower die portion 20 includes a seating portion 21 on which the to-be-molded object P is seated, a lower cam 25 having an inclined surface corresponding to the upper cam 11, a sliding structure 24 allowing the lower cam 25 to move in the first direction, and a cam block 28 connected to the lower cam 25 to form the to-be-molded object P.

In the case of the die 1, the to-be-molded object P is molded into one shape. In the case of recently used high-strength steel materials, especially, steel materials having tensile strength of giga-level or higher, the physical properties of the materials have variations in terms of manufacturing characteristics. In the case of molding through the die 1 having one shape, the degree of springback varies depending on the material variations, causing variations in the shape after molding, resulting in defective products. Therefore, the present disclosure provides a variable die capable of changing a molding shape based on the physical properties of each steel material.

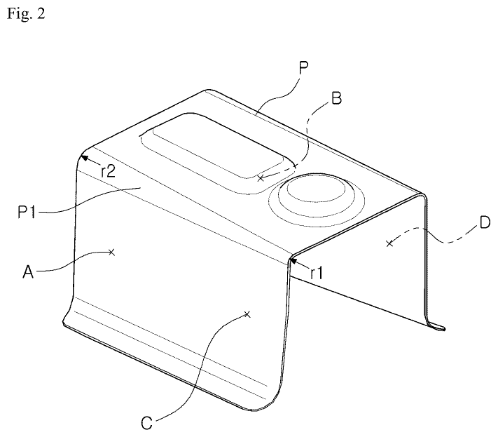

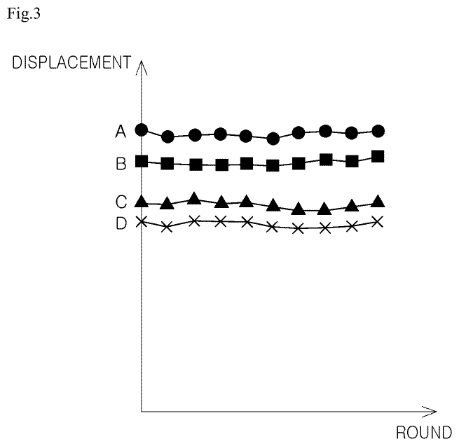

Meanwhile, FIG. 2 is a schematic diagram of a molded product, and FIG. 3 is a graph illustrating molded shapes measured in positions A to D of the molded product of FIG. 2. As illustrated in FIG. 2, in the shape of the molded product, when the radii of curvature r1 and r2 of the molded product changes in the length direction of the product, that is, a product movement direction (the Y-direction in FIG. 1) in which the product faces the front, shown as a letter C, even if the material is the same, the degree of springback may be different. Points A, B, C, and D in FIG. 2 are four points at different positions left and right (the X-direction) and front and back (the Y-direction) at the same height of the molded product, and distances from a reference position at those positions are illustrated in FIG. 3. A round refers to the order in which products were produced, and one product was molded in one round. The molding shape does not change depending on the round.

As illustrated in FIG. 3, it can be seen that the distances from the reference position are different depending on the position in the product molded at once, and it can be seen that this tendency is maintained even if the round changes. In other words, it can be seen that springback continues to occur at positions in which more springback occurs, and it can be seen that, at those positions, springback occurs to be different when the radii of curvature of the molded product are different, that is, distortion occurs in the molded product. Therefore, in order to mold into an accurate shape even with different springbacks, it may be necessary to control molding in the moving direction (the Y-direction) of the product, and the present disclosure provides a variable die capable of adjusting molding, i.e., distortion, in the moving direction of the product.

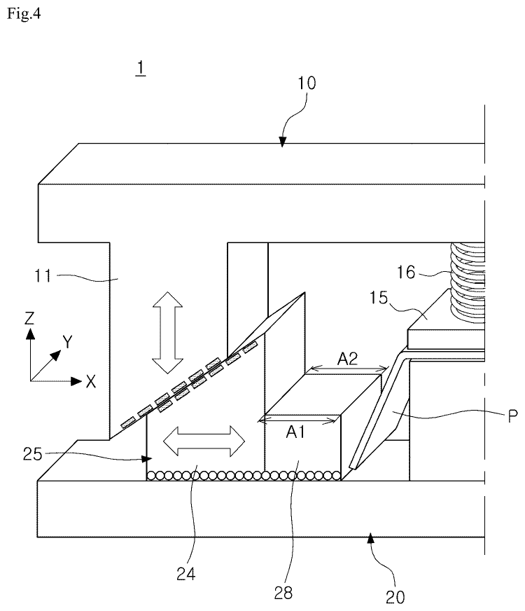

FIG. 4 illustrates a conceptual diagram of a variable die according to an embodiment of the present disclosure.

In FIG. 4, a variable die 1 includes an upper die portion 10 and a lower die portion 20, and the upper die portion 10 includes an upper cam 11, a pressure plate 15 positioning a to-be-molded object P during molding, and a spring 16 elastically supporting the pressure plate 15. The upper cam 11 is formed to have an inclined surface to convert a vertical movement of a movable portion of a press body into a movement in the first direction (the X-direction) toward the to-be-molded object P.

The lower die portion 20 includes a seating portion 21 on which the to-be-molded object P is seated, a lower cam 25 having an inclined surface corresponding to the upper cam 11, a sliding structure 24 allowing the lower cam 25 to move in the first direction, and a cam block 28 connected to the lower cam 25 to form the to-be-molded object P. In the embodiment of FIG. 4, actuators A1 and A2 adjusting the length in the X direction are disposed in different positions in the Y direction of the cam block 28. In other words, the cam block 28 may adjust rotation based on the vertical direction (the Z-direction) by adjusting the length of the actuators A1 and A2, and accordingly, the cam block 28 may be adjusted in response to springbacks occurring to be different in the to-be-molded object P depending on material variations or molding formation of the to-be-molded object P.

In the present embodiment, the position of the cam block 28 may be adjusted by two axes, and according to the position adjustment, the position (the position in the X direction) of the overall cam block 28 may not only be adjusted, but also rotation (rotation around the Z-axis) may also be adjusted, thereby adjusting distortion that may occur in the molded product.

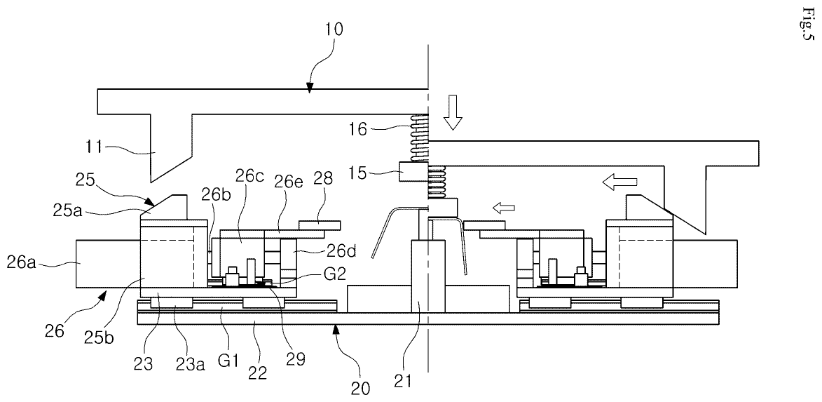

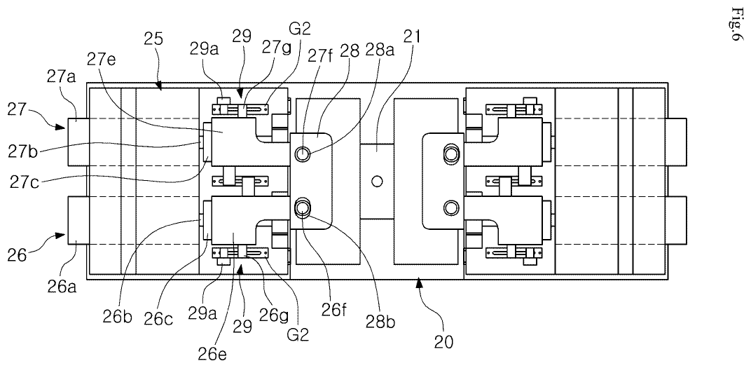

FIGS. 5 to 6 illustrate a variable die according to another embodiment of the present disclosure. FIG. 5 illustrates a schematic front view of the variable die 1 according to an embodiment of the present disclosure, and FIG. 6 illustrates a schematic plan view of the variable die 1 according to an embodiment of the present disclosure.

As illustrated in FIGS. 5 and 6, the variable die 1 includes an upper die portion 10 and a lower die portion 20, and the upper die portion 10 includes an upper cam 11, a pressure plate 15 positioning the to-be-molded object P during molding, and a spring 16 elastically supporting the pressure plate 15. The upper cam 11 is formed to have an inclined surface to convert a vertical movement of the movable portion of the press body into a movement in the first direction (the X-direction) toward the to-be-molded object P.

The lower die portion 20 includes a lower body 22 coupled to a press body; a seating portion 21 connected to the lower body 22 and on which the to-be-molded object P is seated; and a molding portion including a lower cam 25 connected to the lower body 22, disposed on both sides of the seating portion 21, and corresponding to the upper cam 11, and linearly moving in the first direction toward the seating portion 21 by the upper cam 11 and the lower cam 25.

The molding portion includes the lower cam 25; a base plate 23 connected to the lower cam 25 and configured to be movable in the first direction; actuators 26 and 27 partially fixed to the base plate 23, and the cam block 28 connected to the actuators 26 and 27. A first actuator 26 and a second actuator 27 spaced apart from each other in the second direction different from the first direction are connected to the cam block 28, and the actuators 26 and 27 include a structure stretchable in the first direction.

The lower cam 25 includes a cam structure 25a and a connection portion 25b connected to a lower portion of the cam structure 25a, having a hollow structure to form space in which the actuators 26 and 27 are disposed, and connected to the base plate 23. The base plate 23 is connected to the lower body 22 via a first LM guide G1, and in order for the lower cam 25 to be moved in the first direction by the upper cam 11, the first LM guide G1 includes rail extending in the first direction and a guide portion 23a moved along the rail. The base plate 23 causes the components connected to the base plate 23 to move as a whole in the first direction.

The first and second actuators 26 and 27 are connected to the base plate 23. Outer portions of the first and second actuators 26 and 27 are fixed to the base plate 23. Here, the outer portion refers to a portion located relatively far from the to-be-molded object P so that the cam block 28 may move in the X direction by the actuators 26 and 27. The first and second actuators 26 and 27 are located in the hollow portion of the connection portion 25b.

The first actuator 26 includes a motor 26a fixed to the base plate 23, a screw 26b connected to a rotating shaft of the motor 26a and rotated by the motor 26a, a moving block 26c with threads corresponding to the screw 26b formed on the inside thereof, a support portion 26d rotatably supporting the end of the screw 26b passing through the moving block 26c, a connection member 26e connecting the moving block 26c to the cam block 28, a pin 26f connected from the connection member 26a to a connection hole 28b of the cam block 28, and a protrusion 26g protruding from the moving block 26c. In the first actuator, the motor 26a may be referred to as a driving unit in that it provides power, the screw 26b and the moving block 26c may be referred to as an extendable portion because they move in the first direction, and the connection member 26e may be referred to as a connection portion in that it is connected to the cam block 28.

The moving block 26c is movably connected to the base plate 23 in the first direction. That is, the moving block 26c is connected to the base plate 23 through a second LM guide G2, and the protrusion 26g may be connected to the second LM guide G2.

Similar to the first actuator 26, the second actuator 27 includes a motor 27a fixed to the base plate 23, a screw 27b connected to a rotating shaft of the motor 27a and rotated by the motor 27a, a moving block 27c with threads corresponding to the screw 27b formed on the inside thereof, a support portion 27d rotatably supporting the end of the screw 27b passing through the moving block 27c, a connection member 27e connecting the moving block 27c to the cam block 28, a pin 27f connected from the connection member 27a to the connection hole 28a of the cam block 28, and a protrusion 27g protruding from the moving block 27c.

In the first and second actuators 26 and 27, an external power source may be connected to the motors 26a and 27a, and a controller (not shown) is connected to the motors 26a and 27a to drive the motors 26a and 27a, thereby moving the moving blocks 26c and 27c forwardly or backwardly in the first direction. When the moving blocks 26c and 27c move forwardly, the cam block 28 connected to the first and second actuators 26 and 27 moves forwardly. The first and second actuators 26 and 27 may move independently, and the cam block 28 may move forwardly/backwardly/rotate as the first and second actuators 26 and 27 move separately.

Meanwhile, a distance measurement sensor 29 may be disposed on the side of the first and second actuators 26 and 27 to measure a moving distance of the actuators 26 and 27. The distance measurement sensor 29 may include a laser sensor 29a irradiating a laser toward the protrusions 26g and 27b, and then detecting the laser reflected therefrom, and the laser sensor 29a may be fixed to the base plate 23 and measure a distance of the protrusions 26g and 27g protruding from the moving blocks 26c and 27c, thereby measuring a distance by which the cam block 28 is moved by the first and second actuators 26 and 27, The distance measurement sensor 29 is connected to the aforementioned controller to determine whether the motors 26a and 27a are controlled accurately.

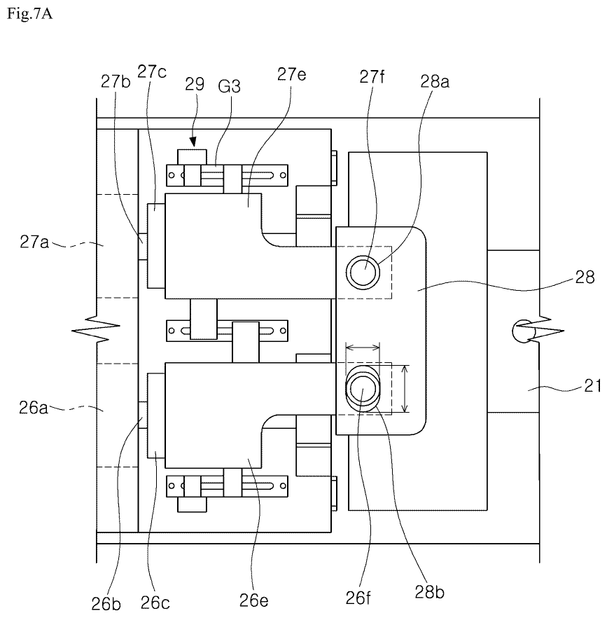

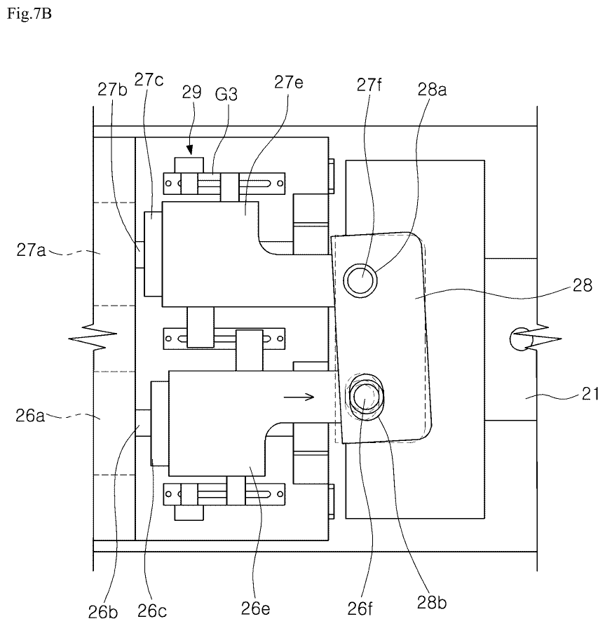

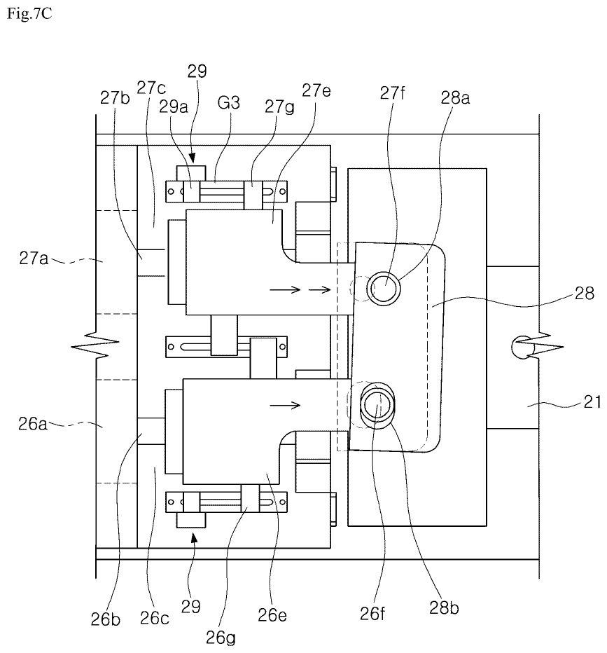

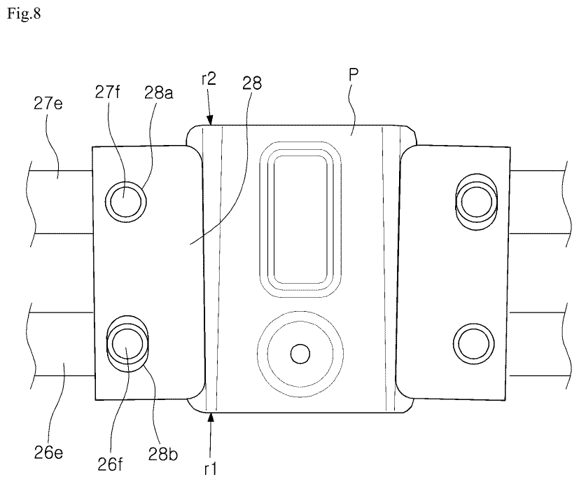

A configuration in which the cam block 28 and the first and second actuators 26 and 27 are connected will be described with reference to FIG. 7A. FIGS. 7A to 7C are enlarged views of the cam block portion of FIG. 6 according to each state, and FIG. 8 is a schematic diagram of a variable die forming a molded product according to the embodiment of FIG. 5.

As illustrated in FIG. 7A, the first and second actuators 26 and 27 include pins 26f and 27f connected to the ends of the connection members 26e and 27e, respectively, and the pins 26f and 27f are inserted into the first and second connection holes 28a and 28b of the cam block 28 so that the first and second actuators 26 and 27 are connected to the cam block 28. In order for the cam block 28 to be rotated in the Z direction, one of the first connection hole 28a and the second connection hole 28b is formed to be longer than a diameter of the pins 26f and 27f in the second direction, accurately, a direction, parallel to a pressure surface 28c of the cam block 28.

The pins 26f and 27f of the first and second actuators 26 and 27 are formed to have a circular cross-section so that the cam block 28 may rotate. One of the first and second connection holes 28a and 28b (the first connection hole in the present embodiment) is formed as a circular hole having an inner diameter corresponding to the pin 27f, and thus, in the present embodiment, the first connection hole 28a and the pin 27f of the second actuator 27 are connected to be rotatable only. Meanwhile, the other (the second connection hole in the present embodiment) of the first and second connection holes 28a and 28b includes a pair of semicircular portions having an inner diameter corresponding to the pin 26f and a straight portion between the pair of semicircular portions. The straight portion of the second connection hole 28b extends in the second direction, that is, in a direction parallel to the pressing surface 28c, and therefore, a length L of the second connection hole 28b in the second direction is formed to be longer than a length D in the first direction. The shape of the second connection hole 28b allows the circular pin 26f to move in the second connection hole 28b, and as the positions of the pins 26f and 27f of the first and second actuators 26 and 27 change, the cam block 28 rotates.

FIG. 7A is a view when the first and second actuators 26 and 27 are located in a basic position, and FIG. 7B illustrates a state in which the cam block 28 is rotated when only the first actuator 26 moves forwardly toward the seating portion 21, that is, moves forwardly in the first direction. FIG. 7C illustrates a state in which the second actuator 27 moves forwardly further than the first actuator when both the first and second actuators 26 and 27 move forwardly. As the first and second actuators 26 and 27 move forwardly together, the cam block 28 moves forwardly overall from its basic position, and as the second actuator 27 moves forwardly further, the cam block 28 rotates in a direction opposite to that of FIG. 7B.

As illustrated in FIG. 8, molding portions are illustrated to be arranged on both sides of the to-be-molded object P. The first and second actuators 26 and 27 are respectively disposed on both sides of the to-be-molded object P and adjust the cam blocks 28 for forming the to-be-molded object P on both sides of the to-be-molded object P. The positions of the first and second connection holes 28a and 28b in the cam blocks 28 disposed on both sides may be arranged symmetrically based on the to-be-molded object P, but as illustrated in FIG. 8, only the connection holes 28a may be arranged diagonally from each other.

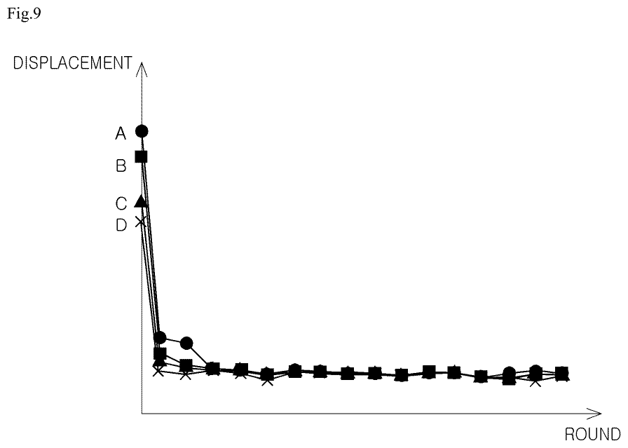

FIG. 9 is a graph illustrating a molded shape of a molded product molded with the variable die 1 of the present disclosure. At first, the degree of springbacks was different for each position as illustrated in the graph of FIG. 3, but, by moving and rotating the cam block 28 through the variable die 1, molding is performed again, springbacks are measured again for each position, the cam block 28 is moved and rotated, and then, molding is performed, thereby rapidly reaching a shape to be formed, and it is possible to accurately form a desired shape despite differences in the amount of springbacks occurring at each position.

The above description has focused on embodiments of the present disclosure, but the present disclosure is not limited thereto and may of course be implemented in various modifications.

1. A variable die comprising:
an upper die portion and a lower die portion,
wherein the upper die portion includes an upper cam,
the lower die portion includes
a lower body;
a seating portion connected to the lower body and on which a to-be-molded object is seated; and a molding portion connected to the lower body, disposed on one side of the seating portion, including a lower cam corresponding to the upper cam, and moving linearly in a first direction toward the seating portion by the upper cam and the lower cam,
wherein the molding portion includes:
the lower cam;
a base plate connected to the lower cam and configured to be movable in the first direction;
an actuator partially fixed to the base plate; and
a cam block connected to the actuator,
wherein a plurality of actuators spaced apart in a second direction, different from the first direction, are connected to the cam block, and
the actuator includes a structure extendable in the first direction.

2. The variable die of claim 1, wherein
the actuator includes a driving unit fixed to the base plate, an extendable portion connected to the driving unit, and a connection portion connecting the extendable portion and the cam block, and
a distance of the extendable portion in the first direction is adjusted by the driving unit.

3. The variable die of claim 2, further comprising a distance sensor connected to the base plate and measuring a position of the extendable portion or the connection portion.

4. The variable die of claim 1, wherein
the actuator includes a first actuator and a second actuator disposed to be spaced apart from the first actuator in the second direction,
the second direction is a direction, perpendicular to the first direction in a horizontal plane including the first direction,
the first actuator is connected to a first connection hole formed in the cam block by a pin,
the second actuator is connected to a second connection hole formed in the cam block by a pin, and
at least one of the first connection hole and the second connection hole has a length greater than a diameter of the pin.

5. The variable die of claim 4, wherein
the first connection hole has an inner diameter corresponding to the diameter of the pin, and
the second connection hole has a length greater than the diameter of the pin in the second direction.

6. The variable die of claim 1, wherein the base plate and the lower body are connected through a first LM guide allowing only a movement in the first direction.

7. The variable die of claim 2, wherein the base plate and the connection portion are connected through a second LM guide allowing only a movement in the first direction.

8. The variable die of claim 1, wherein
the actuator includes:
a motor,
a screw rotated by the motor;
a moving block with threads, corresponding to the screw, formed on the inside; and
a connection member connecting the moving block and the cam block,
wherein the moving block is connected to the base plate through a second LM guide extending in the first direction.

9. The variable die of claim 1, wherein the molding portion is disposed on both sides based on the seating portion.

10. The variable die of claim 9, wherein
the actuator is connected to the controller, and
the controller adjusts a distance of the actuator in the first direction in consideration of a molding result of the to-be-molded object after molding.

11. A press apparatus comprising:
a press body; and
a plurality of dies installed in the press body and molding a material; and
a moving unit moving the material in the plurality of dies,
wherein the plurality of dies include a first die bending a portion of the material and a second die re-molding a bent portion of the material formed in the first die,
wherein the second die is the variable die of claim 1.

12. The press apparatus of claim 11, wherein
the actuator includes a first actuator and a second actuator disposed to be spaced apart from the first actuator in the second direction,
the second direction is a direction, perpendicular to the first direction in a horizontal plane including the first direction,
the first actuator is connected to a first connection hole formed in the cam block by a pin,
the second actuator is connected to a second connection hole formed in the cam block by a pin, and
at least one of the first connection hole and the second connection hole has a length greater than a diameter of the pin.

13. The press apparatus of claim 12, wherein
the first connection hole has an inner diameter corresponding to the diameter of the pin, and
the second connection hole has a length greater than the diameter of the pin in the second direction.

14. The press apparatus of claim 12, wherein
the actuator includes:
a motor,
a screw rotated by the motor;
a moving block with threads, corresponding to the screw, formed on the inside; and
a connection member connecting the moving block and the cam block,
wherein the moving block is connected to the base plate through a second LM guide extending in the first direction.
